(19) United States
(12) Patent Application Publication
(10) Pub. No.: US 2003/0056633 A1
(43) Pub. Date: Mar. 27, 2003

(54) Cutting disc core with noise reduction

(76) Inventors: Kevin Frank Baron, Newbury Park, CA (US); Kraig Mitchell Baron, Oak Park, CA (US); Leon Diehl Jones, Oxnard, CA (US); Scott William Eyler, Ventura, CA (US)

Correspondence Address: Jack C. Munro, Agent of Record, Suite 225, 28720 Roadside Drive, Agoura Hills, CA, 91301, US

(21) Appl. No.: 09/964,926

(22) Filed: Sep. 26, 2001

(51) Int. Cl. B26D 7/27; B23D 57/00

(52) U.S. Cl. 83/665; 83/835

(57) ABSTRACT

A cutting disc core which has a circular shaped body which has a center hole and a circular peripheral edge. Formed within the body and located spaced from the center hole and also the peripheral edge are a series of scroll shaped slits each of which has a longitudinal axis that is displaced at an acute angle relative to a radius line which passes through the slit. Each of the slits may be filled with a filler with this filler comprising an epoxy resin impregnated with aluminum powder. Each of the slits are of scroll shape.

### BACKGROUND OF THE INVENTION

1. Field of the Invention

The field of this invention relates to the construction of a cutting disc core that is to be utilized in forming of a rotary cutting blade with the core being constructed to dampen noise generated during rotation of a cutting blade.

2. Description of the Related Art

In order to manufacture a circular saw blade, there is utilized a thin metallic disc shaped core with the cutting surface to be located on the periphery of the core. The core includes a center hole which is used to mount the saw blade to a motor operated device which will cause rotation of the blade. The rotation of the blade at high speed in contact with the structure that is being cut, which is generally cement, marble, stone, asphalt or other hard substances, causes the blade to vibrate. This vibration produces sound. Generally this sound is at an exceedingly high pitch which is annoying to people anywhere near the saw blade and actually can be damaging to one's ears.

Previously, cutting disc cores have been constructed to damp vibration. One way that vibration damping has been achieved is by cutting slits in the body of the core. Generally, these slits are formed in some regular pattern, such as being arranged the same number of degrees apart and each slit being located in the same direction relative to a radius of the cutting disc core. It has been discovered that a regular pattern of slits is not the most effective in dampening of noise. An irregular pattern has been discovered by the present inventors to be far superior.

Additionally, it has been known to incorporate a filler material within each slit in order to further reduce noise in the operation of the blade. In the past, a desirable form of filler material would be a material that is softer than the material of the blade. One such material that has been used in the past is Babbitt metal, which has a period of vibration different from the period of vibration of the steel core of which the cutting disc core is manufactured. However, it has also been known that the slits may be filled with other material, such as a plastic material.

A commonly constructed form of cutting disc core that is designed to reduce noise is a core that is constructed not of a single material but of different laminated layers. One such blade utilizes thin pieces of steel with a copper layer being sandwiched therebetween. This type of sandwiched type blade has been shown to be a reasonably good noise reducer. However, there is a major disadvantage in using the sandwiched blade. This disadvantage has to do with the cutting segments which constitute small, arcuate, diamond containing blocks which are attached to the peripheral edge of the core. Because of the copper layer, the only effective means of attachment of these cutting blocks is by brazing. Brazing, inherently, is not as strong as laser welding. Therefore, during operation of the cutting block, it is common that some blocks may disengage from the core diminishing the cutting effectiveness of the block which at some point will require replacement. If the core blade could be constructed of a single metallic material, then laser welding could be utilized to secure the cutting segments on the periphery of the blade which will make the blade last a much longer time.

Another desirable feature of using laser welding is that it generates a lot less heat than brazing. The more heat that is generated during the attaching of the cutting blocks to the core, the more likely that the blade will assume a slight warp. The flatter the blade, the less the vibration that is created during operation of the blade. Therefore, using brazing tends to increase the amount of noise because the blade assumes a slight non-flat configuration.

### SUMMARY OF THE INVENTION

A first basic embodiment of cutting disc core with noise reduction which takes the form of a circular shaped body which has a center hole and a continuous peripheral edge. This body is divided into a center section which surrounds and is located directly adjacent the center hole and a peripheral section which is located directly adjacent the peripheral edge. In between the center section and the peripheral section is an intermediate section. Located within the intermediate section are a series of slits. Each longitudinal axis of each slit is displaced at an acute angle relative to a radius line of the body. The slits are arranged randomly, so many of the slits are of different lengths and are located at various acute angles with there being no regular pattern. Each slit is to intersect a radius line of the body.

A further embodiment of this invention is where the basic invention is modified where the width of the intermediate section is forty to sixty percent of the distance from the center to the peripheral edge of the body.

A further embodiment of this invention is where the basic invention is modified by the width of the peripheral section being approximately equal to the width of the center section of the body.

A further embodiment of this invention is where the basic invention is modified by the slits being of a scroll shape.

A further embodiment of this invention is where the basic invention is modified by the slits being cut entirely through the body.

Another embodiment of this invention is where the basic invention is modified by the slits including a filler material with the filler material including powdered aluminum and epoxy resin.

A still further embodiment of this invention is where the basic embodiment is modified by the including of a series of radially oriented slots connecting with the peripheral edge of the body with the inner edge of each of the slots connecting with a separate arcuate shaped transverse slot.

A second basic embodiment of the present invention takes the form of a circular shaped body having a center hole and a continuous peripheral edge with the body divided into a center section which surrounds the center hole and a peripheral section which is located directly adjacent the peripheral edge. In between the center section and the peripheral section is an intermediate section. A series of slits are formed within the intermediate section. The width of the intermediate section is between forty and sixty percent of the distance between the center hole formed within the body and the peripheral edge of the body.

A further embodiment of the present invention is where the second basic embodiment is modified by the width of the center section being approximately equal to the width of the peripheral section.

A still further embodiment of the present invention is where the second basic embodiment is modified by the slits being of a scroll shape.

A still further embodiment of the present invention is where the second basic embodiment is modified by the slits being cut entirely through the body.

A still further embodiment of the present invention is where the slits are filled with a filler material with this filler material including an epoxy resin plus aluminum powder.

A still further embodiment of the present invention is where a series of radially oriented slots connect with the peripheral edge of the body with the inner end of each of the radial slots connecting with a separate arcuate transverse slot.

A third basic embodiment of the present invention comprises a circular shaped body having a center hole and a continuous peripheral edge. The body is divided into a center section which surrounds the center and a peripheral section which is located directly adjacent the peripheral edge. In between the center section and the peripheral edge is an intermediate section. A series of slits are formed within the intermediate section. Each of these slits are scroll shaped.

A still further embodiment of the present invention is where the third basic embodiment is modified by the longitudinal axis of each slit being located at an acute angle relative to an intersecting radius line of the body. The slits are arranged randomly with many slits being of different lengths and are located at various acute angles. Any radius line of said body will intersect a slit.

A still further embodiment of the present invention is where the third basic embodiment is modified by the slits being cut entirely through the body.

A still further embodiment of the present invention is where the third basic embodiment is modified by the slits being filled with a filler material with this filler material including an epoxy plus powdered aluminum.

### BRIEF DESCRIPTION OF THE DRAWINGS

For a better understanding of the present invention, reference is to be made to the accompanying drawings. It is to be understood that the present invention is not limited to the precise arrangement shown in the drawings.

FIG. 1 shows a front view of the cutting disc core constructed in accordance with the present invention;

FIG. 2 is a cross-sectional view through the cutting disc core of the present invention taken along line 2-2 of FIG. 1;

FIG. 3 is a front view of a modified form of a cutting disc core of the present invention; and

FIG. 4 is a cross-sectional view of the modified form of the present invention taken along line 4-4 of FIG. 3.

### DETAILED DESCRIPTION OF THE INVENTION

Referring particularly to the drawings, there is shown the cutting disc core 10 of this invention. Cutting disc core 10 takes the form of a circular shaped disc shaped body which has a center hole 12. The center hole 12 is to be used to mount the core 10 onto a machine to effect the rotation of the core. The machine is not shown and is deemed to be conventional. The core 10 has a peripheral edge 14. Formed within the peripheral edge 14 are a plurality of radial slots 16. Twenty-four in number of slots 16 is shown. However, the number can increase or decrease depending on the diameter of the core 10. The radial slots 16 are generally of equal width with the common width being approximately one-eighth of an inch. However, it is considered to be within the scope of this invention that the width of the slots 16 could be increased or decreased. The radial slots 16 are generally located in an evenly spaced apart arrangement. It is to be noted that the radial slots 16 are of various lengths with generally the length varying between one-half inch to one-inch. It is also noted that generally relative to each radial slot 16, the radial slots located on each side of a radial slot 16 are of different lengths. It has been found to be desirable to not locate the radial slots 16 at all of the same length as there will be a tendency to be created an annular weak line in the core 10 tending to cause creating of a crack within the core 10 at the inner end of each of the radial slots 16. This tendency can be negated by the forming of the slots 16 in various lengths.

The portion of the peripheral edge 14 located between each directly adjacent of pair of radial slots 16 is to define an area to which is to be laser welded a cutting segment (not shown). The mounting of the cutting segments on the core 10 is what produces a cutting blade. It has been found that by locating of an arcuate transverse slot 18 at the inner end of each radial slot 16 that there is a substantially reduced tendency for cracks to be created at the inner end of each radial slot 16 during operation of the cutting blade. The resulting overall configuration of the transverse slot 18 and the radial slot 16 produces an anchor shape. Each of the transverse slots 18 terminate at each end in a small hole 20. Each of the small holes 20 again are to diminish the possibility of creating a crack formed within the blade during operation of the blade. Common areas of producing cracks are generally in the portion of the core 10 that is located closest to the peripheral edge 14.

The cutting disc core 10 is essentially divided into a center section 22 which is located directly adjacent the center hole 12 with the center section 22 having a width B, an intermediate section 24 which is located against the center section 22 with this intermediate section 24 having a width C, and a peripheral section 26 which is located between the peripheral edge 14 and the intermediate section 24 and has a width D. Generally, B equals D but can vary somewhat. The width C is generally in the range of forty to sixty percent of the entire width of the cutting disc core 10. Formed within the intermediate section 24 are a series of scroll shaped slits 28. Each of the scroll shaped slits 28 are basically “S” shaped with each of the S's being formed into a coil forming an outer coil 29 and an inner coil 31. It is to be noted that the slits 28 are to be confined to the intermediate section 24. Placing of the slits 28 in the peripheral section 26 or placing of the slits 28 within the center section 22 will tend to weaken the core and cause premature failure.

The width of each of the slits 28 is generally no more than one-sixteenth of an inch. Each of the slits 28 extend entirely through the body of the core 10. Each scroll shaped slit 28 includes a longitudinal axis 30. It has been found to be desirable that the longitudinal axis 30 of each slit 28 is to be is located at an acute angle A relative to a radius line 32 that passes through the particular scroll shaped slit 28.

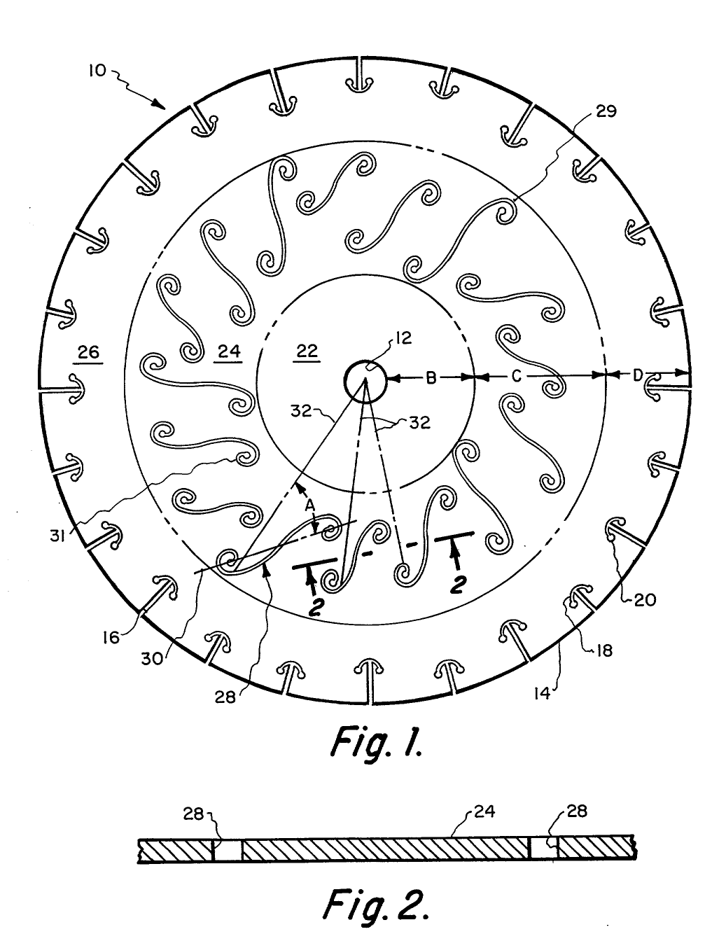

It is to be noted that it is not possible to draw a radius line 32 that does not intersect a slit 28. This has been found to be the best arrangement in order to provide for maximum noise reduction. Usage of the basic embodiment of FIGS. 1 and 2 will result in a core that operates at a substantially reduced decibel level than if the scroll shaped slits 28 were not included within the core 10. The reduced noise level of a core using the configuration in FIGS. 1 and 2 is normally similar to the nmoise level of a laminated type core. It has also been discovered that a scroll shaped slit 28 is far superior to having a straight slit or any other shape of slit. It is also to be noted that, in referring to FIG. 1, the longitudinal axis 30 of each slit 28 is located at various acute angles relative to a radius line 32 that passes through the particular slit 28. There is no regular pattern arrangement for the slits 28 with the slits 28 being located at a random various acute angles A and also formed of various lengths. This irregular random pattern achieves maximum noise reduction. Typical angles for angle A would generally be between ten and thirty degrees.

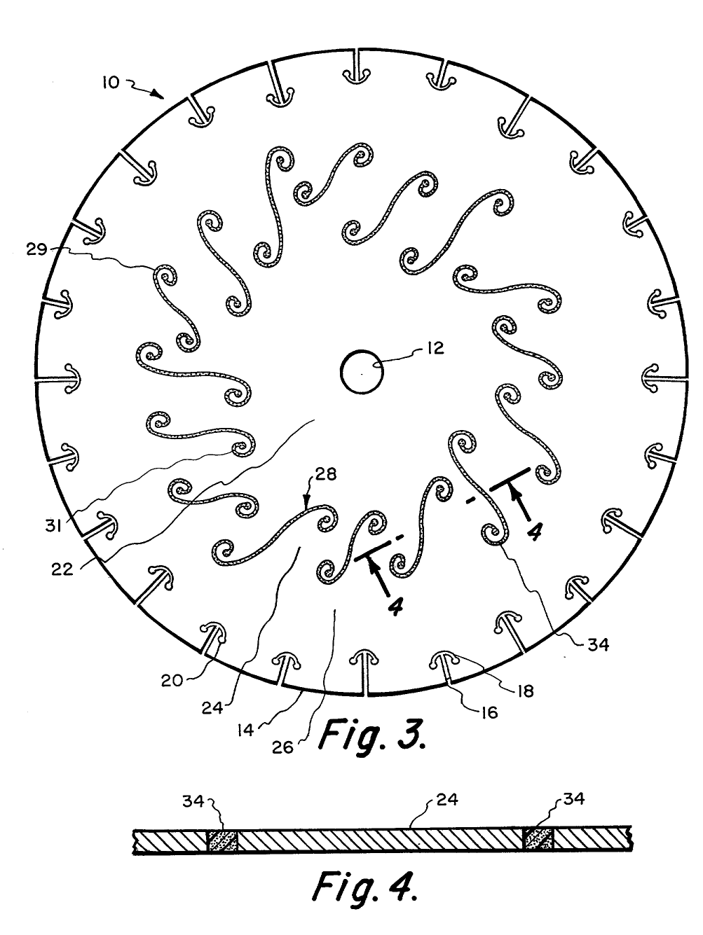

Referring particularly to FIGS. 3 and 4, the scroll shaped slits 28 are to be filled with an epoxy resin composition 34. It has been found to be better to include within the resin 34 an aluminum powder 34 with a four hundred mesh aluminum powder being found to be satisfactory. Typically, the composition 34 will be constructed of thirty-eight percent aluminum powder, thirty-eight percent epoxy binder and twenty-four percent hardener. By use of the composition 34, it is possible to achieve a substantial reduction in noise level during operation of the cutting blade that utilizes cutting disc core 10 of this invention.

Although the scroll shaped slits 28 are shown to be, in essence, a single row, it is possible to use multiple rows, such as two rows. The scroll shaped slits 28 are formed within the core 10 at the beginning of manufacture of the cores 10. The cutting disc cores 10 are then heat treated with the result that the scrolls 28 also function to keep the core 10 as flat as possible. The scrolls 28 also help keep the core 10 flat when operating and also operating at a cooler temperature. When laser welding the cutting segments, which is not shown, onto the peripheral edge 14 of the core 10, the laser welding puts a lot less heat into the core 10 with the result that the core 10 tends to maintain a flatter configuration. The flatter the configuration the less vibration the cutting disc core 10 will incur when performing a cutting operation.

It is considered to be within the scope of this invention that the slits 28 could be only partially filled with the composition 34. It is also considered to be within the scope of this invention that the slits 28 could not necessarily be formed all the way through the core 10 so that, in essence, they would become grooves as opposed to slots. It is also considered to be within the scope of this invention that dimensions B, C and D could vary from the sizes mentioned. The primary distinction is that the slits 28 are to be located so as to be spaced from the center hole 12 and also spaced from the peripheral edge 14. Inserting of the slits 28 within either or both the center section 22 and the peripheral section 26 will cause weakening of the core 10 making it more likely to crack during operation as a cutting blade.

What is claimed is:

1. A cutting disc core with noise reduction comprising:
a circular shaped body having a center hole and a continuous peripheral edge, said body being divided into a center section which surrounds said center hole and a peripheral section which is located directly adjacent said peripheral edge, in between said center section and said peripheral section is an intermediate section; and
a series of slits formed within said intermediate section, each said slit having a longitudinal axis which is located at an acute angle relative to an intersecting radius line of said body, said slits being arranged randomly with many said slits are of different lengths and are located at various acute angles, any said radius line of said body will intersect a said slit.

2. The cutting disc core as defined in claim 1 wherein:
said intermediate section having a width which is between forty and sixty percent of the distance from said center hole to said peripheral edge.

3. The cutting disc core as defined in claim 1 wherein:
the width of said peripheral section being approximately equal to the width of said center section.

4. The cutting disc core as defined in claim 1 wherein:
each of said slits being scroll shaped.

5. The cutting disc core as defined in claim 1 wherein:
each said slit being formed entirely through said body.

6. The cutting disc core as defined in claim 1 wherein:
each said slit including a filler material, said filler material comprising an epoxy resin impregnated with aluminum powder.

7. The cutting disc core as defined in claim 1 wherein:
said body including a series of radially oriented slots formed within said peripheral section, each said radial slot being open at said continuous peripheral edge, said radial slots being of numerous different lengths, each said radial slot connecting with a separate transverse slot, each said transverse slot being formed within said body, each said transverse slot being arcuate.

8. A cutting disc core with noise reduction comprising:
a circular shaped body having a center hole and a continuous peripheral edge, said body being divided into a center section which surrounds said center hole and a peripheral section which is located directly adjacent said peripheral edge, in between said center section and said peripheral section is an intermediate section; and
a series of slits formed within said intermediate section, said intermediate section having a width which is between forty and sixty percent of the distance from said center hole to said peripheral edge.

9. The cutting disc core as defined in claim 8 wherein:
the width of said peripheral section being approximately equal to the width of said center section.

10. The cutting disc core as defined in claim 8 wherein:
each of said slits being scroll shaped.

11. The cutting disc core as defined in claim 8 wherein:
each said slit being formed entirely through said body.

12. The cutting disc core as defined in claim 8 wherein:
each said slit including a filler material, said filler material comprising an epoxy resin impregnated with aluminum powder.

13. The cutting disc core as defined in claim 8 wherein:
said body including a series of radially oriented slots formed within said peripheral section, each said radial slot being open at said continuous peripheral edge, said radial slots being of numerous different lengths, each said radial slot connecting with a separate transverse slot, each said transverse slot being formed within said body, each said transverse slot being arcuate.

14. A cutting disc core with noise reduction comprising:
a circular shaped body having a center hole and a continuous peripheral edge, said body being divided into a center section which surrounds said center hole and a peripheral section which is located directly adjacent said peripheral edge, in between said center section and said peripheral section is an intermediate section; and
a series of slits formed within said intermediate section, each of said slits being scroll shaped.

15. The cutting disc core as defined in claim 14 wherein:
each of said slits having a longitudinal axis which is located at an acute angle relative to an intersecting radius line of said body, said slits being arranged randomly with many said slits are of different lengths and are located at various said acute angles, any said radius line of said body will intersect a said slit.

16. The cutting disc core as defined in claim 14 wherein:
each said slit being formed entirely through said body.

17. The cutting disc core as defined in claim 14 wherein:
each said slit including a filler material, said filler material comprising an epoxy resin impregnated with aluminum powder.
